(19) United States
(12) Patent Application Publication
(10) Pub. No.: US 2002/0009163 A1
(43) Pub. Date: Jan. 24, 2002

(54) Discrimination apparatus

(75) Inventors: Kanako Miyazaki, Osaka (JP); Yasuhiro Nomura, Osaka (JP)

Correspondence Address: MCDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 09/825,357

(22) Filed: Apr. 4, 2001

(30) Foreign Application Priority Data
May 12, 2000 (JP) 2000-139972

(51) Int. Cl. H04L 27/06

(52) U.S. Cl. 375/340

(57) ABSTRACT

A discrimination apparatus shows whether data can be viewed and listened to or not in a signal reproduced from a recording media. A determining unit judges whether the signal reproduced from the recording media in which broadcast signals recorded are digitally reproduced from digital broadcast including data signal after digital recording. A display control unit outputs a display control signal according to the judging result input from the determining unit. A display unit shows whether the data of data signal can be viewed and listened to or not depending on the display control signal.

### FIELD OF THE INVENTION

The present invention relates to a discrimination apparatus of video appliance for receiving, recording or reproducing digital broadcast including data signals.

### BACKGROUND OF THE INVENTION

Digital broadcast has started recently, and it is possible to transmit data signals, in addition to video signals and audio signals, by multiplexing in MPEG stream. By making use of this service, data broadcast is presented in various forms including data independent of broadcast program, data relating to broadcast program, electronic program guide, subtitles, and two-way service data. The user can retrieve, view and listen to such data.

By utilizing the data broadcast, the user can view and listen to data by controlling the receiver as shown in the following examples.

For example, when the weather forecast is transmitted from the broadcast station as data signal, desired weather information can be obtained by entering the region and date.

In a recording and reproducing apparatus, operation for recording and reproducing data signal is explained by referring to FIG. 2.

FIG. 2 is a block diagram showing a configuration of an apparatus for recording and reproducing digital broadcast signals.

In FIG. 2, a receiving unit 201 receives digital broadcast wave signals.

A decoder 202 decodes MPEG stream signals multiplexed by video signal, audio signal and data signal received in the receiving unit 201 into analog television signals such as NTSC signals.

FIG. 3 is a simplified schematic diagram of NTSC signal and MPEG stream signal.

Specifically, FIG. 3A shows an NTSC signal, and FIG. 3B shows an MPEG stream signal.

A recording unit 204 records the entered MPEG stream signal in an analog recording unit 204A in the case of analog recording, or in a digital recording unit 204D in the case of digital recording, according to an instruction from a control unit 206.

The control unit 206 controls the recording unit 204 and reproducing unit 205 according to an instruction from an operation unit 207.

The reproducing unit 205 reproduces the signal recorded on recording media according to an instruction from the control unit 206.

The operation unit 207 gives an instruction to the control unit 206 depending on the key operation by the user.

In the recording and reproducing apparatus having such configuration, the operation is described below.

For analog recording of digital broadcast, the operation unit 207 selects analog recording. At this time, the control unit 206 instructs the recording unit 204 to record in analog mode.

The decoder 202 decodes the MPEG stream signal of broadcast program received in the receiving unit 201, and outputs an NTSC signal. The analog recording unit 204A records this output signal. Such analog recording of digital broadcast program is necessary for reproducing and viewing a digital broadcast program by using a conventional analog reproducing apparatus.

On the other hand, for digital recording of digital broadcast, the recording unit 204 records the MPEG stream signal received in the receiving unit 201 in the digital recording unit 204D according to instructions from the operation unit 207 and control unit 206.

Operation for reproducing signals recorded in recording media is explained below.

When a play key is pressed, it is transmitted from the operation unit 207 to the control unit 206. The control unit 206 issues a reproduction instruction to the reproducing unit 205. The reproducing unit 205 reproduces the signals recorded in the recording media.

For analog recording of data signal, the MPEG stream signal is decoded into an analog television signal such as NTSC signal, and recorded. At this time, information of data signal is not recorded.

Therefore, if signals are reproduced from the recording media in which a program of digital broadcast is recorded in analog mode, data signals cannot be reproduced.

Thus, in a recorded program, when reproducing the portion in which data broadcast is made in the original broadcast program, data of data broadcast may not be viewed. For example, when the television program is a weather forecast broadcast, complementary information by data broadcast such as individual regional weather cannot be fetched.

On the other hand, by digital recording of digital signals, together with video signals and audio signals, data signals are also recorded as MPEG stream signals. Therefore, the reproduced MPEG stream signals are decoded in the same manner as a case of receiving the broadcast. At the time of reproduction, for example, when the data broadcast is transmitted as complementary information in a television program, such data can be viewed.

Comparing digital recording and analog recording of data signals, hence, at the time of reproduction, data signals can be reproduced in the former case, and data signals cannot be reproduced in the latter case.

### SUMMARY OF THE INVENTION

In the light of the above problems, it is hence an object of the invention to present a discrimination apparatus showing whether the data signals reproduced from recording media can be viewed or not.

The discrimination apparatus of the invention comprises:

a determining unit for judging whether the signal reproduced from the recording media is digital reproduction of digital broadcast including data signals after digital recording or not, and

a display control unit for outputting a display control signal based on the judging result from the determining unit.

In this configuration, the user can discriminate whether viewing of data is possible or not. Therefore, the user can judge whether the data can be viewed or not while viewing a broadcast program showing data broadcast and related information on a screen. Hence, the recording and reproducing apparatus easier to use by the user is presented.

### BRIEF DESCRIPTION OF THE DRAWINGS

FIG. 1 is a block diagram showing a configuration of a recording and reproducing apparatus including a discrimination apparatus according to an embodiment of the invention.

FIG. 2 is a block diagram showing a configuration of a conventional recording and reproducing apparatus.

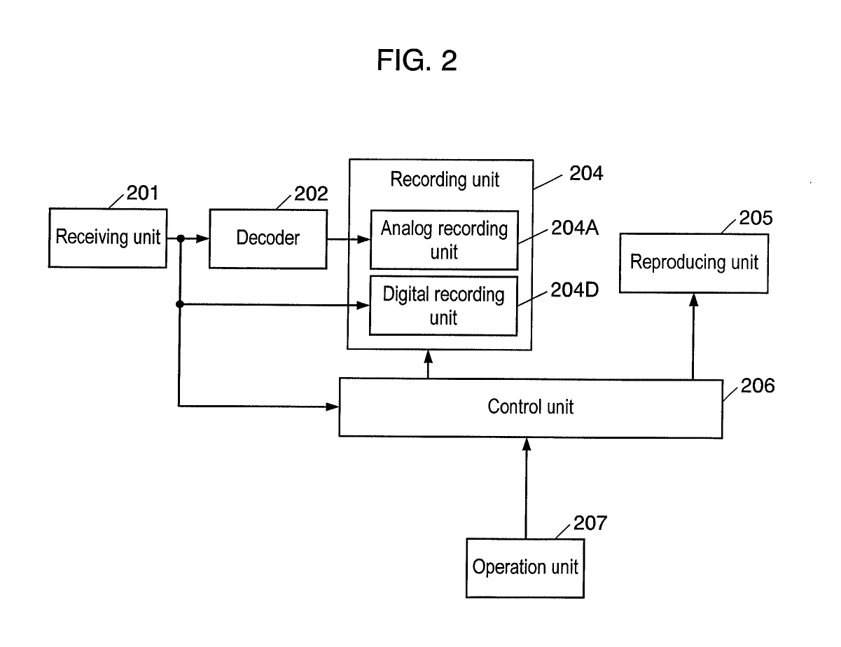

FIG. 3 is a schematic diagram of signals.

### DESCRIPTION OF THE PREFERRED EMBODIMENT

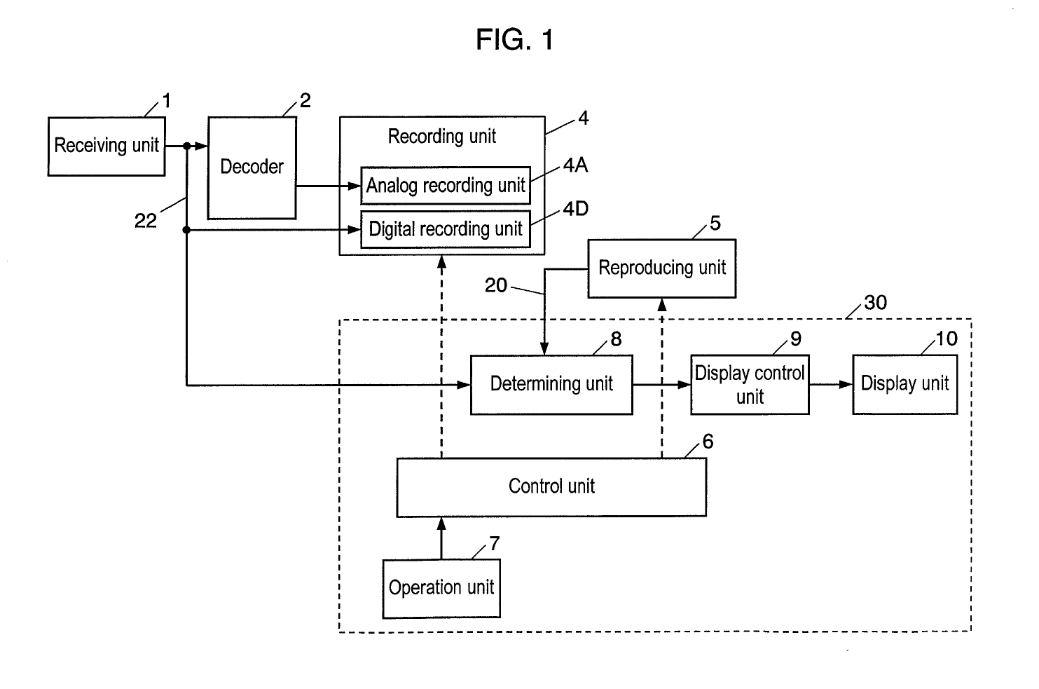

A preferred embodiment of the invention is described by referring to FIG. 1.

FIG. 1 is a block diagram showing a configuration of the discrimination apparatus of the invention.

In FIG. 1, a receiving unit 1 receives digital broadcast such as digital satellite broadcast. A decoder 2 decodes the MPEG stream signal of digital broadcast signal received in the receiving unit 1 into an analog television signal such as NTSC signal.

A recording unit 4 comprises an analog recording unit 4A for analog recording, and a digital recording unit 4D for digital recording.

A reproducing unit 5 reproduces signals in digital mode or analog mode depending on whether digital recording or analog recording is made in recording media such as video tape, according to an instruction from a control unit 6.

The control unit 6 instructs reproducing operation or recording operation to the reproducing unit 5 or recording unit 4 according to a command from an operation unit 7.

The operation unit 7 sends a command to the control unit 6 depending on the key operation.

A determining unit 8 judges whether the signal 20 reproduced from the recording media in which received signals are recorded is a digital reproduced signal of the digital broadcast including data signal after digital recording or not.

The determining unit 8 further judges whether the signal 22 input from the receiving unit is digital broadcast signal including data signal or not.

(1) Whether digital recording or analog recording can be discriminated, for example, as follows.

a) For example, the number of pulses per time determined by the control signal of the video tape may vary between digital recording and analog recording. Therefore, it is possible to make the judgment by determining the difference in the number of pulses.

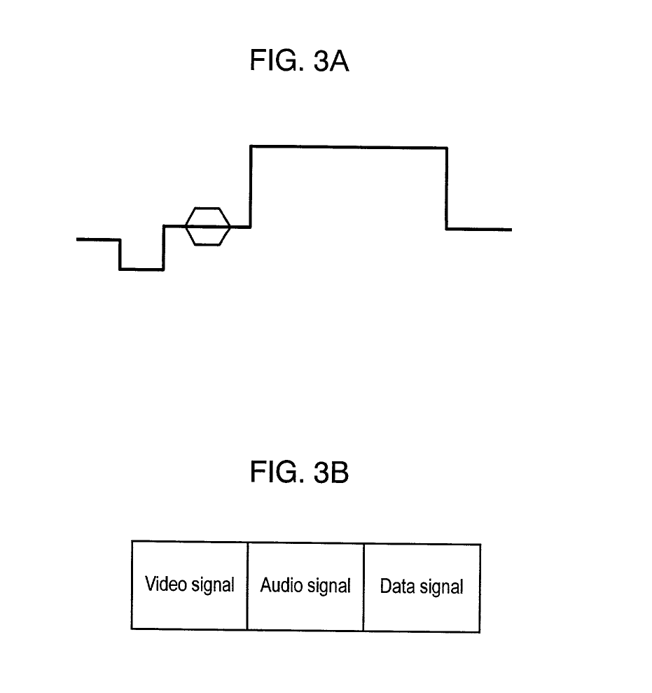

b) Or the determining unit 8 can make the judgment by detecting whether the reproduced signal is a stream signal composed of digital data as shown in FIG. 3B or not.

(2) Whether the signal includes data signal or not is determined by judging if there is a header specific to data signal, that is, elementary stream of data broadcast.

Thus, the determining unit 8 judges how the digital broadcast signal including data signal is processed in the input signal. Next, the determining unit 8 outputs the output signal showing its result to a display control unit 9.

The display control unit 9 controls a display on the basis of the judging result in the determining unit 8.

A display unit 10 is composed of an indication lamp, an on-screen display device, and others, and displays the result of determination in the determining unit 8 according to an instruction from the display control unit 9.

In FIG. 1, the display unit 10 is installed inside the discrimination apparatus 30, but the display unit 10 may be also disposed outside the discrimination apparatus 30.

(1) In the discrimination apparatus having such configuration, operation for recording and reproducing the digital broadcast including data signal is explained below.

1) When the operation unit 7 selects digital recording or analog recording, and operates the recording, the control unit 6 outputs a record instruction to the digital recording unit 4D or analog recording unit 4A, and executes recording.

a) In the case of analog recording, the MPEG stream signal of the broadcast program received in the receiving unit 1 is decoded in the decoder 2, and an NTSC signal is obtained. The analog recording unit 4A records this decoded signal.

b) On the other hand, in the case of digital recording, the digital recording unit 4D records the MPEG stream signal received in the receiving unit 1.

2) When the play key is pressed in the operation unit 7, the control unit 6 reproduces the signal recorded in the recording media by the reproducing unit 5. The determining unit 8 judges whether the signal 20 reproduced from the recording media is a digital reproduced signal of digital broadcast including data signal after digital recording or not.

a) When the reproduced signal is judged to be a digital reproduced signal of digital broadcast including data signal after digital recording, the determining unit 8 outputs the judging result showing that the reproduced signal is such a signal to the display control unit 9. The display unit 10 shows the result of judgment.

b) On the other hand, when judged not to be a digital reproduced signal of digital broadcast including data signal after digital recording, the determining unit 8 sends the judging result to the display control unit 9.

The display unit 10 shows the judging result. Or it may be displayed in the display unit 10 only when the data signal can be viewed and listened to.

(2) When receiving digital broadcast including data signal, the operation is as follows.

The determining unit 8 judges whether the output 22 of the receiving unit 1 is a received digital broadcast signal such as that from a digital satellite broadcast including data signal or not.

1) When the determining unit 8 judges the digital broadcast including data signal is received, it sends the judging result showing that the digital broadcast including data signal is being received to the display control unit 9. The display unit 10 displays the judging result.

2) On the other hand, when judged not to be digital broadcast including data signal, the determining unit 8 outputs the judging result to the display control unit 9. The display unit 10 displays the judging result.

It may be also displayed in the display unit 10 only when the data broadcast signal can be viewed.

Thus, the discrimination apparatus of the embodiment displays that data of data broadcast can be viewed and listen to in the following cases.

(a) When the signal reproduced from the recording media in which broadcast is recorded is digital reproduction of digital broadcast including data signal after digital recording, or

(b) When receiving digital broadcast including data signal, it is shown that the data indicated by the data signal can be viewed and listened to. Thus, the user knows whether possible to view or not.

Therefore, the user can judge whether the data can be viewed or not while viewing or reproducing a broadcast program showing data broadcast and related information on a screen. Hence, the recording and reproducing apparatus easier to use by the user is presented.

What is claimed is:

1. A discrimination apparatus comprising:
a determining unit for judging whether the digital broadcast signal including data signal contained in an input signal is digitally processed, and outputting an output signal to show the result, and
a display control unit for outputting a display control signal according to the output signal.

2. The discrimination apparatus of claim 1,
wherein the input signal is a signal reproduced from recording media, and
said determining unit judges whether the input signal is a digitally reproduced signal from digital broadcast including data signal after digital recording.

3. The discrimination apparatus of claim 1,
wherein the input signal is a received signal of digital broadcast, and
said determining unit judges whether the input signal is a digitally received signal from digital broadcast including data signal.

4. The discrimination apparatus of claim 1, further comprising:
a receiving unit for receiving digital broadcast,
wherein the input signal is one of i) a signal reproduced from recording media, and ii) an output signal of said receiving unit, and
a) in the case that the input signal is a signal reproduced from the recording media, said determining unit judges whether the input signal is digitally reproduced from digital broadcast including data signal after digital recording, and
b) in the case that the input signal is an output signal of said receiving unit, said determining unit judges whether the input signal is received from digital broadcast including data signal.

5. The discrimination apparatus of claim 1,
wherein said determining unit judges whether the input signal is a digital broadcast signal including a data signal, depending on
whether i) the input signal includes bit stream data and ii) data specific to data signal is included in the bit stream.

6. The discrimination apparatus of claim 2,
wherein said determining unit judges whether the input signal is digitally reproduced from digital broadcast including a data signal after digital recording, depending on whether i) the input signal includes bit stream data, and ii) data specific to data signal is included in the bit stream.

7. The discrimination apparatus of claim 3,
wherein said determining unit judges whether the input signal is digitally received from digital broadcast including data signal, depending on whether i) the input signal includes bit stream data, and ii) data specific to data signal is included in the bit stream.

8. The discrimination apparatus of claim 4,
wherein, depending on whether i) the input signal includes bit stream data, and ii) data specific to data signal is included in the bit stream,
i) in the case that the input signal is a signal reproduced from the recording media,
said determining unit judges whether the input signal is digitally reproduced from digital broadcast including data signal after digital recording, or
ii) in the case that the input signal is an output signal of said receiving unit,
said determining unit judges whether the input signal is received from digital broadcast including data signal.
